(19) United States
(12) Patent Application Publication
(10) Pub. No.: US 2024/0383181 A1
(43) Pub. Date: Nov. 21, 2024

(54) REMOTE CONTROLLER FOR FEEDBACK CONTROL AND METHODS FOR SAME

(71) Applicant: THE PROCTER & GAMBLE COMPANY, Cincinnati, OH (US)

(72) Inventor: Brian Matthew Burns, Mason, OH (US)

(21) Appl. No.: 18/692,292

(22) PCT Filed: Dec. 14, 2021
(86) PCT No.: PCT/US2021/063232

§ 371 Date: Mar. 14, 2024

Related U.S. Application Data
(60) Provisional application No. 63/244,955, filed on Sep. 16, 2021.

(51) Int. Cl. B29C 45/77; B29C 45/78

(52) U.S. Cl. CPC B29C 45/77; B29C 45/78; B29C 2945/76006; B29C 2945/7619; B29C 2945/76257; B29C 2945/76498; B29C 2945/76531; B29C 2945/76665; B29C 2945/76969; B29C 2945/76993

(57) ABSTRACT

Systems and methods describe supplementing a “native controller” of an injection molding with a remote controller, via a retrofitting of the remote controller the injection molding machine. The remote controller may thereby modify control of an injection molding process based upon a control strategy of the remote controller, e.g., by providing a modified feedback signal to be used by a control algorithm of the native controller in lieu of a feedback signal previously used by the native controller. The remote controller may generate the “modified feedback signal” based upon its own control algorithm and control strategy. Furthermore, the remote controller may be configured to robustly account for behavior of the native controller so as to provide stable control of a control variable of the process according to a setpoint defined by the remote controller.

### FIELD OF THE DISCLOSURE

The present disclosure relates generally to the field of remote controllers for controlling a native feedback controller of an apparatus, such as an injection molding apparatus.

### BACKGROUND

Injection molding is a technology commonly used for manufacturing of products made from meltable material, such as thermoplastic polymers. During an injection molding process, a solid thermoplastic resin, typically in the form of small pellets or beads, is introduced into an injection molding machine via a hopper, and the injection molding machine melts the resin under heat and pressure (e.g., within a heated barrel). In an injection molding cycle, the molten material is forcefully injected into a mold cavity having a particular desired cavity shape. The injection of the molten material may be facilitated, for example, by a reciprocating screw or auger pushing the molten material through a nozzle. The injected plastic is held under pressure in the mold cavity and is subsequently cooled and removed as a solidified product having a shape closely resembling the mold cavity shape. The solidified product may be removed, for example, by separating two halves defining the mold cavity to expose and remove the solidified product. After removal of the solidified product, the injection molding machine can be returned to its original position and prepared for another injection molding cycle (e.g., another introduction of solid thermoplastic resin via the hopper to mold another product).

Conventionally, an injection molding machine includes a natively-installed controller that controls various components of the injection molding machine during an injection molding process. Typically, the natively-installed controller (“native controller” or “original controller”) is configured to sense and control a particular variable according to a desired value or “setpoint” of the control variable during the injection molding process, wherein the setpoint may increase or decrease during various stages of an injection molding cycle. The control variable may, for example, be a temperature of the heated barrel, a velocity of the reciprocating screw, or a pressure of the molten material at or near any of the heated barrel, the nozzle, or the cavity. In any case, significant or unpredictable deviation from a control variable setpoint during the injection molding process may produce a solidified product having undesirable properties (e.g., improper shape or consistency), or may incur increased wear upon the injection molding machine.

### SUMMARY

Systems and methods of the present disclosure generally involve supplementing a “native controller” of an injection molding machine (or “injection molding apparatus”) with a remote controller, via a retrofitting of the remote controller the injection molding machine. By retrofitting the remote controller (or “retrofit controller”) to the injection molding machine, the control architecture of the injection molding machine can be modified based upon a control strategy of the remote controller. For example, in embodiments described herein the remote controller may generate a feedback signal to be provided to a “native” control algorithm of the native controller, in lieu of another signal previously used and/or generated thereby. The remote controller may generate a “modified feedback signal” based upon its own “remote” control strategy having its own setpoint behavior, control algorithm(s), etc., thereby modifying the control strategy of the native controller via introduction of the modified feedback signal. Moreover, as will be described herein, the remote controller may be specifically configured to more robustly account for a native setpoint control strategy of the native controller, thereby allowing more accurate control of a control variable setpoint according to the control strategy of the remote controller itself.

In an embodiment, a method is provided for manipulating control of an operation of an actuation unit of an apparatus using a remote controller configured via a retrofitting of the remote controller to a native controller of the apparatus. The native controller prior to the retrofitting may be configured to control the operation of the actuation unit based upon a first signal indicative of a first control variable of the apparatus. The method may include (1) sensing the first control variable of the apparatus at a sensor, (2) generating the first signal based upon the first control variable, and/or (3) generating a second signal based upon a first setpoint of the native controller for the first control variable. The method may further include, at the remote controller, (4) receiving the first and second signals, (5) generating a control signal based upon the first signal and a second setpoint of the remote controller for the first control variable, (6) combining the generated control signal and the second signal to produce a modified feedback signal, and/or (7) transmitting the modified feedback signal to the native controller in lieu of the first signal. The method may still further include, at the native controller. (8) controlling the operation of the actuation unit based at least in part on the modified feedback signal.

In some examples, the apparatus includes an injection molding apparatus including a heated barrel and an injection shaft, with the actuation unit being operatively coupled to the injection shaft. In these examples, the operation of the actuation unit may facilitate operation of the injection shaft with respect to the heated barrel.

In some examples, the injection shaft of the injection molding apparatus includes a reciprocating screw, and the operation of the actuation unit facilitates a reciprocation of the reciprocating screw. In some examples, the injection shaft of the injection molding apparatus includes a plunger, and the operation of the actuation unit facilitates a reciprocation of the plunger. In some examples, the actuation unit includes one of a hydraulic motor and an electric motor.

In some examples, the first control variable of the injection molding apparatus is one of a injection pressure of the heated barrel, a temperature of the heated barrel, and a volume of a hopper included in the injection molding apparatus. In other examples, the first control variable of the injection molding apparatus is a melt pressure of the heated barrel. In still other examples, the first control variable of the injection molding apparatus is a cavity pressure of the injection molding apparatus.

In some examples, the generating of the control signal at the remote controller includes (1) comparing the first signal to the second setpoint for the first control variable, and (2) generating the control signal based upon a difference between the first signal and the second setpoint. More particularly, in some examples, the generating of the control signal at the remote controller includes providing the difference as an input to a PID control algorithm of the remote controller to generate the control signal. Still more particularly, in some approaches, the PID control algorithm of the remote controller is a first PID control algorithm, and the controlling of the operation of the actuation unit at the native controller based upon the modified feedback signal includes providing the modified feedback signal as an input to a second PID control algorithm of the native controller that is different from the first PID control algorithm.

In some examples, the second setpoint of the remote controller is a setpoint for the first control variable. In other examples, the second setpoint of the remote controller is a setpoint for a second control variable different from the first control variable.

In another embodiment, an apparatus is provided. The apparatus may include (1) an actuation unit, (2) a native controller in communication with the actuation unit and configured to control an operation of the actuation unit, the native controller storing a first setpoint of the native controller for a first control variable of the apparatus, (3) a remote controller in communication with the native controller via a retrofitting of the remote controller to a native controller, the native controller prior to the retrofitting being configured to control the operation of the actuation unit based upon a first signal indicative of first the control variable of the apparatus, and/or (4) a sensor in communication with the remote controller and configured to sense the first control variable and generate a first signal based upon the first control variable. The remote controller of the apparatus may be configured to (1) receive, from the sensor, the first signal, (2) receive, from the native controller, a second signal indicative of the first setpoint for the first control variable, (3) generate a control signal based upon the first signal and a second setpoint of the remote controller for the first control variable, (4) combine the generated control signal and the second signal to produce a modified feedback signal, and/or (5) transmit the modified feedback signal to the native controller in lieu of the first signal. The native controller of the apparatus may be configured to control the operation of the actuation unit based at least in part on the modified feedback signal.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale. For example, the dimensions and/or relative positioning of some of the elements in the figures may be exaggerated relative to other elements to help to improve understanding of various embodiments of the present invention.

FIG. 1 illustrates a schematic view of an injection molding apparatus, in accordance with some embodiments;

FIG. 2 illustrates a block diagram of a control architecture of an injection molding apparatus comprising a native controller and a remote controller, in accordance with some embodiments; and

FIG. 3 illustrates a graph of a measured control variable over time, in accordance with some embodiments.

### DETAILED DESCRIPTION

Embodiments described herein generally relate to systems and methods of producing products via an injection molding machine (or “injection molding apparatus”). More particularly, embodiments described herein involve controlling an injection molding process using a “remote controller” configured via a retrofitting of the remote controller to the injection molding machine.

An injection molding machine is typically provided with an on-board “native controller,” with the native controller being originally configured to control an injection molding process implemented by the machine. However, the configuration of the native controller may be rendered ineffective or suboptimal after the original manufacturing of the machine, for example due to deterioration of the machine, discovery of improved control techniques, and/or desire to operate the injection molding machine to produce a different product. At a high level, the use of a remote controller as described herein may allow the remote controller to modify the manner in which the native controller controls an operation of the injection molding machine, using logic of the remote controller without requiring the native controller to be removed from its physical and logical position in the injection molding machine.

Prior to the retrofitting, a native controller of the injection molding machine may be configured to control the injection molding process via a first control algorithm (i.e., one or more algorithms, including for example a proportional-integral-derivative (PID) control algorithm). The first control algorithm may generally be configured to control the injection molding process by controlling a particular control variable of the process according to a setpoint defined by the native controller. The control variable may include, for example, a temperature of a heated barrel of the injection molding machine a velocity of the reciprocating screw of the injection molding machine, and/or a molten material pressure at or near any of the heated barrel, a nozzle, a cavity, or another particular location in the injection molding machine. Other examples are possible. The setpoint of the control variable may vary during various phases of an injection molding cycle. For example, the native controller may be configured to increase the setpoint at the start of a cycle, either gradually (e.g., setpoint “ramping”) or instantaneously (e.g., a “step increase” or “step decrease”). The control algorithm of the native controller may be configured to repeatedly sense a value of the control variable during the injection molding process (e.g., via one or more sensors) and determine a difference or “error” between the control variable setpoint and the control variable as sensed. Based upon the determined error, the control algorithm of the native controller may output a control signal to control an operation of the injection molding apparatus (e.g., an operation of an actuation unit for the reciprocating screw) to affect the control variable, which is sensed again for a subsequent iteration of the control loop as described above.

As will be described in subsequent portions of the present disclosure, retrofitting the remote controller to the injection molding machine may include connecting one or more sensors and/or other outputs of the injection molding machine to the remote controller. In some embodiments, but not necessarily, the retrofitting may include disconnecting the same sensor(s) and/or other output(s) from the native controller. In any case, the one or more sensors to be connected to the remote controller may include the particular sensor or sensors configured to sense the value of the control variable (which may be the same control variable for the remote controller as for the native controller, e.g., a temperature or pressure at a particular location in the injection molding machine). The remote controller may additionally be configured, via the retrofitting, to receive output from the native controller indicating the value of the setpoint of the native controller for the control variable (e.g., the setpoint as of the most recent iteration of the control loop). The remote controller may, based upon the received outputs and a control algorithm of the remote controller (i.e., one or more control algorithms), generate and provide a “modified feedback signal” to the native controller for use as an input to the control algorithm of the native controller (e.g., to be used in lieu of the value of the control variable itself).

Notably, the control algorithm of the remote controller (i.e., one or more control algorithms) may include a PID control algorithm different from the control algorithm of the native controller. Additionally or alternatively, the remote controller may be configured to define behavior of the setpoint differently from the native controller. Thus, the use of the remote controller may intelligently modify the manner in which the native controller controls the operation of the injection molding machine, based upon the setpoint and the control algorithm of the remote controller, rather than the setpoint of the native controller. Moreover, by receiving for the setpoint of the native controller, the control logic remote controller may account for the native controller setpoint in a manner that prevents undesirable behavior of the control variable, whereby the value of the control variable oscillates unpredictably due to concurrent influence of the multiple setpoints defined by the native controller and remote controller, respectively. This undesirable behavior will be discussed further in subsequent portions of the present disclosure.

The use of the remote controller may improve control of the injection molding machine, for example, (1) by allowing for adjustment of the setpoint in a more optimal manner over the course of an injection molding cycle, (2) by controlling the control variable more closely to the remote controller setpoint at any given time, and/or (3) by otherwise modifying the setpoint or other control structure in a way that produces a superior molded product than the native controller may be capable of facilitating alone. Moreover, these benefits may be achieved without an operator needing to physically remove the native controller from the injection machine or logically remove the native controller from the control loop. As the native controller is often built integrally with the injection molding machine, removal of the native controller or modification of the control architecture of the native controller can often be time consuming, expensive, or even impossible in some instances. Thus, via the systems and methods described herein, control improvements for an injection molding machine may be achieved via a remote controller retrofitted to the injection molding machine, while avoiding the difficulties ordinarily associated with modifications to an originally-manufactured native controller.

In some embodiments, a control strategy implemented via the remote controller may include “low, substantially constant pressure injection molding” techniques. The term “substantially constant pressure” may be used herein with respect to a melt pressure of the thermoplastic material, wherein deviations from a baseline melt pressure do not produce meaningful changes in physical properties of the thermoplastic material. For example, “substantially constant pressure” includes, but is not limited to, pressure variations for which viscosity of the melted thermoplastic material does not meaningfully change. The term “substantially constant” in this respect includes deviations of approximately 30% from a baseline melt pressure. For example, the term “a substantially constant pressure of approximately 4600 psi” includes pressure fluctuations within the range of about 6000 psi (30% above 4600 psi) to about 3200 psi (30% below 4600 psi). A melt pressure is considered substantially constant as long as the melt pressure fluctuates no more than 30% from the recited pressure.

### Example Injection Molding Apparatus

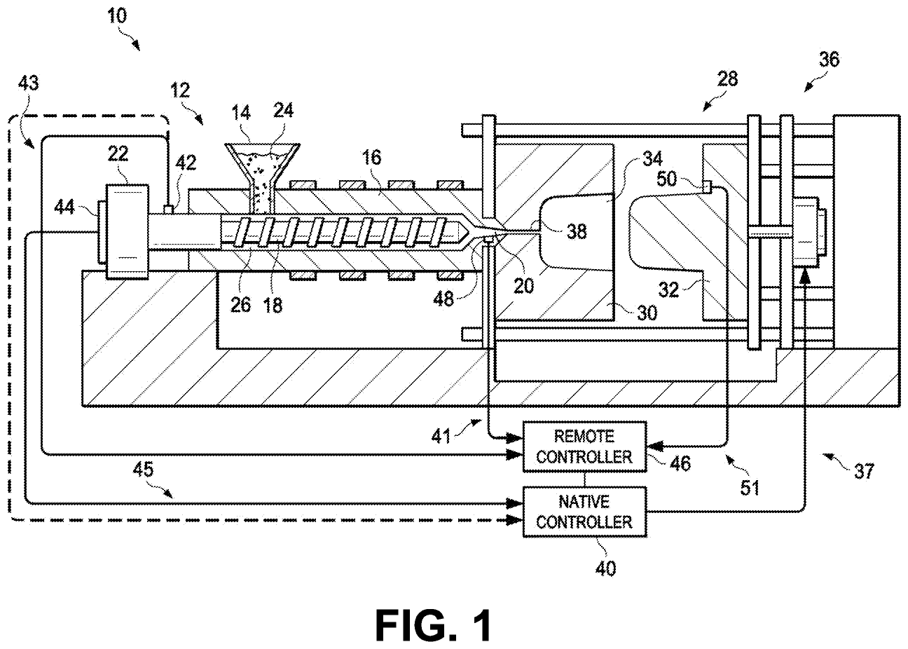

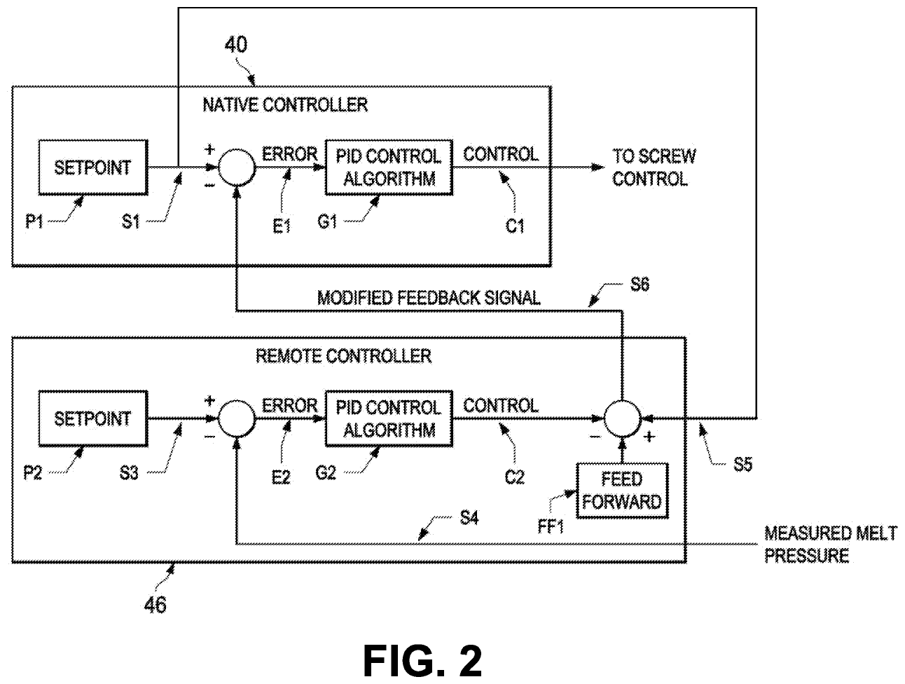

In connection with FIGS. 1-2, wherein like numbers indicate the same or corresponding elements, FIG. 1 illustrates a schematic view of an injection molding apparatus 10 for producing molded plastic products, according to some embodiments of the present disclosure.

The injection molding apparatus 10 can include an injection molding unit 12 that includes a hopper 14, a heated barrel 16, a reciprocating screw 18, and a nozzle 20. The reciprocating screw 18 can be disposed in the heated barrel 16 and configured to reciprocate with respect to the heated barrel 16. An actuation unit 22 can be operably coupled to the reciprocating screw 18 to facilitate powered reciprocation of the reciprocating screw 18. In some embodiments, the actuation unit 22 can include a hydraulic motor. Alternatively, in some embodiments, the actuation unit 22 can include an electric motor. In embodiments, an actuation unit can additionally or alternatively include a valve, a flow controller, an amplifier, or any of a variety of other suitable control devices for injection molding apparatuses or non-injection molding apparatuses. Thermoplastic pellets 24 can be placed into the hopper 14 and fed into the heated barrel 16. Once inside the heated barrel 16, the thermoplastic pellets 24 can be heated (e.g., to between about 130 degrees C. to about 410 degrees C.) and melted to form a molten thermoplastic material 26. The reciprocating screw 18 can reciprocate within the heated barrel 16 to drive the molten thermoplastic material 26 into the nozzle 20.

The nozzle 20 can be associated with a mold 28 having first and second mold portions 30, 32 that cooperate to form a mold cavity 34. A clamping unit 36 can support the mold 28 and can be configured to move the first and second mold portions 30, 32 between a clamped position (i.e., portions 30 and 32 in contact, not shown) and an unclamped position (as shown in FIG. 1). When the first and second mold portions 30, 32 are in the clamped position, molten thermoplastic material 26 from the nozzle 20 can be provided to a gate 38 defined by the first mold portion 30 and into the mold cavity 34. As the mold cavity 34 is filled, the molten thermoplastic material 26 can take the form of the mold cavity 34. Once the mold cavity 34 has been sufficiently filled, the reciprocating screw 18 can stop, and the molten thermoplastic material 26 is permitted to cool within the mold 28. Once the molten thermoplastic material 26 has cooled and is solidified, or at least partially solidified, the first and second mold portions 30, 32 can be moved to their unclamped positions to allow the molded part to be removed from the mold 28. In some embodiments, the mold 28 can include a plurality of mold cavities (e.g., multiple mold cavities 34) to increase overall production rates (i.e., to mold multiple ones of a same product and/or multiple different products during a same cycle).

The clamping unit 36 can apply a clamping force in the range of approximately 1000 pounds per square inch (psi) to approximately 6000 psi during the molding process to hold the first and second mold portions 30, 32 together in the clamped position. To support these clamping forces, the mold 28, in some embodiments, can be formed from a material having a surface hardness from more than about 165 Brinell Hardness Number (BHN) to less than 260 BHN, although materials having surface hardness BHN values of greater than 260 may be used as long as the material is easily machinable, as discussed further below. In some embodiments, the mold 28 can be a class 101 or 102 injection mold (e.g., an “ultra-high productivity mold”).

The injection molding apparatus 10 can include a native controller 40 that is in signal communication with various components of the injection molding apparatus 10. For example, the native controller 40 can be in signal communication with a screw control 44 via a signal line 45. The native controller 40 can command the screw control 44 (e.g., via a control signal) to advance the reciprocating screw 18 at a rate that maintains a desired molding process, such that variations in material viscosity, mold temperatures, melt temperatures, and other variations influencing filling rate of the mold cavity 34, are taken into account by the native controller 40. Adjustments may be made by the native controller 40 immediately during the molding cycle, or corrections can be made in subsequent cycles. Furthermore, several signals, from a number of cycles can be used as a basis for making adjustments to the molding process by the native controller 40.

In one embodiment, when the actuation unit 22 is a hydraulic motor, the screw control 44 can include a hydraulic valve associated with the reciprocating screw 18. In another embodiment, when the actuation unit 22 is an electric motor, the screw control 44 can include an electric controller associated with the reciprocating screw 18. In the embodiment of FIG. 1, the native controller 40 can, for example, generate a signal that is transmitted from an output of the native controller 40 to the screw control 44 to control a rate of reciprocation of the reciprocating screw 18.

The native controller 40 can be an on-board controller that is original to the injection molding unit 12 and built together with the injection molding unit 12. As such, modifications to the control architecture of the native controller 40 or removal of the native controller 40 can be time consuming, expensive and in some instances impossible.

The native controller 40 can be any of a variety of suitable controllers for controlling the molding process. In some embodiments, the native controller 40 may be a PID controller natively configured to implement a PID control algorithm. The native controller 40 can be responsible for controlling a variety of different functions on the injection molding apparatus 10, such as, for example, movement of the clamping unit 36 via a signal line 37. Particularly, in its natively-installed configuration (prior to a retrofitting), the native controller may be configured to control a control variable associated with the injection molding process. The control variable may, for example, be a temperature or a pressure associated with the molten thermoplastic material 26 at a particular location in the injection molding unit 12. A controlled molten thermoplastic pressure may correspond, for example, to (1) an injection pressure detected via an injection pressure sensor 42 located at or near the actuation unit 22, (2) a melt pressure detected via a melt pressure sensor 48 located at or near the nozzle 20, or (3) a cavity pressure detected via a cavity pressure sensor 50 located proximate to an end of the mold cavity 34. The native controller 40 may generally be configured to provide a control signal to control an operation of the injection molding unit 12 (e.g., a signal to the screw control 44 to control the reciprocating screw 18) based upon the sensed control variable being provided as an input to the control algorithm of the native controller 40 (e.g., based upon comparison of the sensed control variable and a setpoint defined by the native controller 40).

The injection pressure sensor 42 can facilitate detection (direct or indirect) of the injection pressure inside of the heated barrel 16 (i.e., the pressure of the heated barrel 16 at the beginning of the reciprocating screw 18) by providing a feedback signal via a signal line 43 to the native controller 40. The native controller 40, in some embodiments, can detect the injection pressure from the feedback signal and can control (e.g., feedback control) the pressures within the injection molding apparatus 10 by controlling the screw control 44, which controls the rates of injection by the injection molding unit 12.

The melt pressure sensor 48 can facilitate detection (direct or indirect) of the actual melt pressure (e.g., the measured melt pressure) of the molten thermoplastic material 26 at or near the nozzle 20. The melt pressure sensor 48 may or may not be in direct contact with the molten thermoplastic material 26. In some embodiments, the melt pressure sensor 48 can be a pressure transducer that transmits an electrical signal via a signal line 41 to an input of the native controller 40 in response to the melt pressure at the nozzle 20. In some embodiments, the melt pressure sensor 48 can facilitate monitoring of any of a variety of additional or alternative characteristics of the molten thermoplastic material 26 at the nozzle 20 that might indicate melt pressure, such as temperature, viscosity, and/or flow rate, for example. If the melt pressure sensor 48 is not located within the nozzle 20, the native controller 40 can be set, configured, and/or programmed with logic, commands, and/or executable program instructions to provide appropriate correction factors to estimate or calculate values for the measured characteristic in, at, or near the nozzle 20. It is to be appreciated that sensors other than a melt pressure sensor can be employed to measure any other characteristics of the molten thermoplastic material 26, the screw 18, the barrel, or the like that is known in the art, such as, temperature, viscosity, flow rate, strain, velocity, etc. or one or more of any other characteristics that are indicative of any of these.

The cavity pressure sensor 50 may facilitate detection (direct or indirect) of the melt pressure of the molten thermoplastic material 26 in, at, or near the nozzle 20. The cavity pressure sensor 50 may or may not be in direct contact with the molten thermoplastic material 26. In some embodiments, the cavity pressure sensor 50 can be a pressure transducer that transmits an electrical signal via a signal line 51 to an input of the native controller 40 in response to the cavity pressure within the mold cavity 34. In other embodiments, the cavity pressure sensor 50 can facilitate monitoring of any of a variety of additional or alternative characteristics of the thermoplastic material 26 or the mold 28 that might indicate cavity pressure, such as strain and/or flow rate of the molten thermoplastic material 26, for example. If the cavity pressure sensor 50 is not located within the mold cavity 34, the native controller 40 can be set, configured, and/or programmed with logic, commands, and/or executable program instructions to provide appropriate correction factors to estimate or calculate values for the measured characteristic of the mold 28.

Still referring to FIG. 1, a remote controller 46 (e.g., a PID controller) can be in signal communication with the native controller 40, the injection pressure signal 42, the melt pressure sensor 48, and/or the cavity pressure sensor 50. Prior to retrofitting the remote controller 46 to the injection molding apparatus 10, the native controller 40 can be in signal communication with any one or more of the injection pressure sensor 42, melt pressure sensor 48, and cavity pressure sensor 50 in the manner described above. To retrofit (e.g., associate) the remote controller 46 to the injection molding apparatus 10, output from one or more of the injection pressure sensor 42, melt pressure sensor 48, and/or the cavity pressure sensor 50 may be connected to the remote controller 46 (and optionally, disconnected from the native controller 40), thereby diverting sensor output from the sensor(s) to the remote controller 46 in lieu of the native controller 46. Once the retrofit is complete, the native controller 40 may no longer directly receive feedback signals from the one or more sensors disconnected from the native controller 40. Instead, the remote controller 46 receives these feedback signals, and generates and transmits a modified feedback signal to the native controller 40 that enhances the operation of the native controller 40 by affecting the manner in which the native controller 40 controls the operation of the injection molding apparatus 10. The native controller 40 and the remote controller 46 thus operate in a closed-loop type control arrangement that mimics the arrangement that existed prior to addition of the remote controller 46.

In some embodiments as described above, the injection pressure sensor 42, melt pressure sensor 48, and cavity pressure sensor 50 already exist on the injection molding unit 12 prior to the retrofitting and are in signal communication with the native controller 40. In such embodiments, retrofitting of the remote controller 46 to the injection molding apparatus 10 involves disconnecting the sensors from the native controller 40 and reconnecting the sensors to the remote controller 46. Alternatively, though, in some embodiments, one or more of the injection pressure sensor 42, the melt pressure sensor 48, and the cavity pressure sensor 50 may not already exist in the injection molding unit 12 prior to the retrofitting. In these embodiments, retrofitting of the remote controller 46 to the injection molding apparatus 10 may include installing one or more sensors to the injection molding unit 12 and connecting the installed sensor(s) to the remote controller 46.

In some embodiments, retrofitting the remote controller 46 to the injection molding apparatus 10 may include diverting (or installing and connecting) still other sensor output to the remote controller 46 instead of the native controller 42 in a manner analogous to that described above, wherein the still other sensor(s) are configured to measure a control variable to which a control strategy of the native controller 42 and/or remote controller 46 pertains (e.g., a temperature sensor, flow sensor, etc.).

Still additionally to the above, the process of retrofitting the remote controller 46 to the injection molding apparatus 10 may include connecting an output of the setpoint of the native controller 40 to the remote controller 46. That is, whereas the native controller 40 prior to the retrofitting may provide the native controller setpoint to the control algorithm of the native controller 40, the native controller 40 after the retrofitting may additionally provide its setpoint via a signal communication to the remote controller 46. It should be understood that, in light of the fact that the setpoint defined by the native controller may change over the course of the injection molding cycle (e.g., as a product of ramping or stepping-up of the control variable setpoint during control iterations or “shots” that make up a molding cycles), the providing of the native controller setpoint to the remote controller 46 may include providing the setpoint each time the native controller 40 defines the control variable setpoint (e.g., at each iteration of the control loop). Thus, the remote controller 46 maintains awareness of the current value of the native controller setpoint, so as to correctly provide a modified feedback signal to be provided to the native controller 40, as described herein.

An example block diagram of the feedback relationship between the native controller 40 and the remote controller 46 is illustrated in FIG. 2. At the remote controller 46, a control variable setpoint P2 is defined, representing a desired melt pressure for the injection molding apparatus 10 at a given time. A signal S4 may be provided to the remote controller 46 that indicates an actual, measured value of the melt pressure, e.g. as measured by the melt pressure sensor 48 and provided to the remote controller 46 upon the melt pressure sensor 48 being connected to the remote controller 46.

It should be noted that, although the control variable to which setpoint P2 in the example of FIG. 2 is the melt pressure of the injection molding apparatus 10, the control variable in other embodiments may be a different control variable pertaining to operation of the injection molding apparatus 10, e.g., a molten material pressure elsewhere in the apparatus (e.g., injection pressure or cavity pressure), a temperature, a material flow, a screw velocity, or another suitable variable. Moreover, the control variable for which the setpoint P2 is defined at the remote controller 46 may in some embodiments be the same control variable for which the native controller 40 is configured to define a setpoint P1. In these embodiments, the signal P4 may be substituted accordingly with a signal transmitted to the remote controller 46 by one or more other sensors suitable for directly or indirectly measuring the control variable (such that the control variable to which the signal P4 matches the control variable for which setpoints P2 and P1 are defined). In other embodiments, though, the control variables for setpoints P2 and P1 may differ. That is, the remote controller 46 may be configured to perform setpoint control of a different control variable than the native controller 40. For example, the setpoint P2 defined at the remote controller 46 may correspond to a desired melt pressure, whereas the setpoint P1 defined at the native controller 40 may correspond to a desired injection pressure or another measurable variable. In these embodiments, the measured variable indicated by signal S4 may correspond to the control variable defined by the setpoint P2 of the remote controller 46 (such that the remote controller 46 to calculate the error signal E2).

Still referring to FIG. 2, the setpoint P2 may be provided via the remote controller 46 via a signal S3 and may be compared to the actual melt pressure to generate an error signal E2 (i.e., defining a difference between the values of the setpoint P2 and the actual melt pressure). The error signal E2 may be provided to a PID algorithm G2 that generates a control signal C2 based at least in part upon the error signal E2. A signal S5 can be provided to the remote controller 46 that indicates the setpoint P1 defined by the native controller 40 (e.g., the setpoint P1 as most recently defined by the native controller 40, e.g., in the immediately preceding control iteration). The control signal C2 and the signal S5 can be combined to or compared to each other to produce a modified feedback signal S6. In some embodiments, the modified feedback signal S6 can also include a feedforward component FF1 combined control signal C2 and the signal S5. Additionally or alternatively, the modified feedback signal S6 may include still other suitable control components that facilitate generation of an effective modified feedback signal.

The modified feedback signal S6 can be transmitted to the native controller 40 in lieu of a feedback signal for the control variable of the native controller 40. For example, in embodiments wherein the native controller 40 prior to the retrofitting is configured to define the setpoint P1 for the desired melt pressure or desired injection pressure, the modified feedback signal S6 is transmitted to the native controller in lieu of a feedback signal from the injection pressure sensor 42 (shown in dashed lines in FIG. 1) or the melt pressure sensor 48. Put differently, the modified feedback signal S6 provided via the retrofitting replaces the pre-existing control feedback of the native controller 40. In some embodiments, the modified feedback signal S6 can be transmitted over a unidirectional transmission link between the native controller 40 and the remote controller 46. In such embodiments, the native controller 40 does not transmit any signals to the remote controller 46.

At the native controller 40, the operation of the injection molding apparatus 10 (e.g., operation of the actuation unit 220) can be controlled according to the modified feedback signal S6. For example, a setpoint P1 can be provided that represents a desired injection pressure of the actuation unit 22. The setpoint P1 can be compared against the modified feedback signal S6 and an error signal E1 can be generated. The error signal E1 can be provided to a control algorithm G1 (e.g., a PID control algorithm) that generates a control signal C1 that commands the screw control 44 to advance the reciprocating screw 18 at a rate that causes the injection pressure to converge towards the desired injection pressure indicated by the setpoint P1.

Although the native controller 40 is controlling the operation of the injection molding apparatus 10 (e.g., via defining the setpoint P1 and using the control algorithm G1 to generate the control signal C1), the modified feedback signal S6 from the remote controller affects the generation of the control signal C1 from the native controller 40, in a manner that actually controls the operation of the injection molding apparatus 10 via the setpoint P2 and the control algorithm G2. Effectively, because the value of the setpoint P1 from the native controller 40 is canceled out by the logic at the remote controller 46 in combination with the native controller 40, the operation of the injection molding apparatus 10 can be reliably controlled based upon the setpoint P2 and the second control algorithm G2, with the native controller setpoint not interfering in the retrofitted operation. Notably, this affect may be achieved regardless of whether the native controller 40 and the remote controller 46 are configured to perform control of a same control variable (e.g., both controllers configured to control an injection pressure), or whether instead the native controller 40 and the remote controller 46 are configured to perform control of different control variables (e.g., the native controller 40 is configured to control injection pressure, whereas the remote controller 46 is configured to control melt pressure). The remote controller 46 can thus provide the capability to control the melt pressure of the injection molding unit 12 without requiring reprograming/reconfiguration of the control architecture of the native controller 40. As such, the remote controller 46 can be a cost effective and straightforward solution to add functionality to the injection molding apparatus 10 where the native controller 40 is not capable of providing such functionality independently.

During a molding cycle, the melt pressure of the injection molding unit 12 can be changed by changing the setpoint P2. In one embodiment, different setpoints can correspond to a different stage of the molding cycle. For example, to initiate the initial injecting stage, a setpoint can be provided that causes the melt pressure to increase enough to begin melting the thermoplastic pellets 24 and distributing the melt to the nozzle 20. Once the melt pressure has increased enough to begin filling the mold cavity 34, the setpoint may be modified to initiate the filling stage at a pressure that is appropriate to properly fill the mold cavity 34. Once the mold cavity 34 is almost filled (e.g., end of fill), the setpoint can be modified once again to decrease enough to initiate the packing stage and hold at a substantially constant melt pressure during the holding stage.

The native controller 40 and/or the remote controller 46 can be implemented in hardware, software or any combination of both and can have any control arrangement having one or more controllers for accomplishing control. It is to be appreciated that, although the native controller 40 is described as sensing and controlling the injection pressure of the actuation unit 22, a native controller 40 can be configured to sense and control any of a variety of suitable alternative control variables, such as, for example, a temperature of the heated barrel 16, a volume of the hopper 14, or velocity of the reciprocating screw 18. It is also to be appreciated that, although the remote controller 46 is described as providing the capability to control the melt pressure of the injection molding unit 12, a remote controller using the injection pressure of the actuation unit 22 can be configured to sense and control any of a variety of suitable alternative control variables, such as, for example, cavity pressure.

### Example Behavior of Monitored Variable(s) in Injection Molding Apparatus

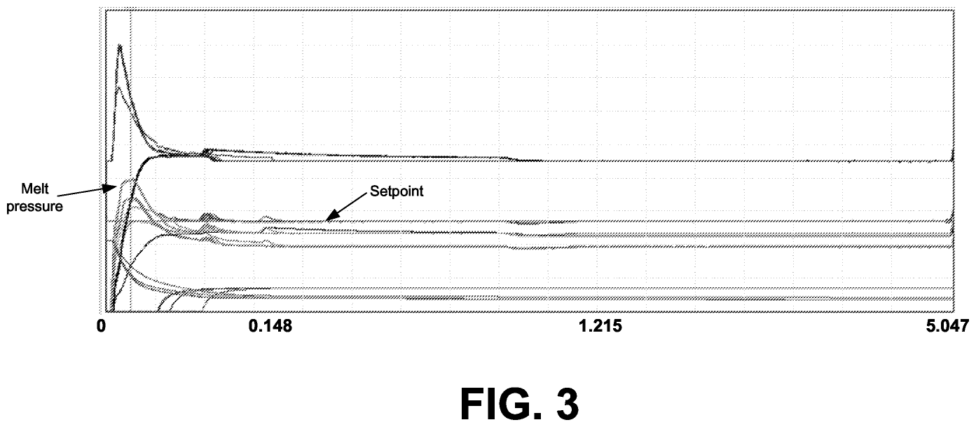

FIG. 3 illustrates a graph of a measured control variable over time, in accordance with some embodiments of the present disclosure. In this instance, a measured melt pressure (y-axis) of an injection molding apparatus (e.g., the injection molding apparatus 10 of FIG. 1) is charted over a time period (x-axis) associated with operation of the injection molding apparatus. In the example of FIG. 3, an objective of controlling the injection molding apparatus is controlling a melt pressure of the injection molding apparatus (the “control variable”) according to a setpoint of the injection molding apparatus for the melt pressure.

At the “zero” time marker, a step change to the melt pressure setpoint is introduced, requiring a control algorithm (e.g., PID algorithm) of a controller of the injection molding apparatus to increase the melt pressure to meet the melt pressure setpoint (e.g., for example, the desired melt pressure may be increased at or near the beginning of an injection molding cycle). That is, the controller modifies its output to cause the melt pressure to approach the setpoint.

A common effect in control is overshoot, wherein attempts to raise or lower the control variable to the new setpoint causes the control variable to move past the setpoint, requiring a correction in the reverse direction from the controller. The correction may, in turn, cause the setpoint overshoot the setpoint in the reverse direction. Effectively, the attempts by the controller to bring the control variable to the setpoint may instead cause the control variable to oscillate in either direction around the setpoint. Objectives in controlling a controlled variable in a process include (1) mathematically understanding the patterns and causes of oscillations and other undesirable behaviors of the control variable (e.g., causes of oscillations and sources of disturbances), and (2) adjusting the control of the control variable based upon the mathematical understanding (e.g., by tuning the proportional gain, integral gain, and derivative gain components of a PID control algorithm) to more closely match the control variable to the setpoint.

As described previously in the present disclosure, undesirable effects may be encountered when attempting to retrofit a native controller of an injection molding apparatus via a remote controller. Particularly, the simultaneous influence of the remote controller and native controller upon the control variable may produce unpredictable, multi-order oscillation of the control variable around both the remote controller setpoint and native controller setpoint. In implementations in which the native and remote controllers use different setpoints but are tuned identically (e.g., the same proportional, integral, and derivative tuning values), the magnitude of overshoot and oscillation of the control variable may increase based upon the difference between the native controller setpoint and remote controller setpoint. Effectively, the difference between native and remote controller setpoints may act as a gain in the control loop. When the remote controller observes this gain (as it contributes to the error signal calculated at the remote controller, the control algorithm of the remote controller may attempt to compensate for the error may cause the control variable to overshoot in the opposite direction, with this effect repeating as the remote controller attempts to stabilize the control variable at the remote controller setpoint.

The undesirable effects described above may be mitigated or avoided by applying the techniques of the present disclosure. Particularly, a retrofitting of the remote controller to the native controller may include connecting the native controller setpoint to the remote controller, such that the remote controller 46 receives the most recent value of the native controller setpoint (e.g., the setpoint as of the last iteration of the control loop). Referring back to FIG. 2, this connection via signal line S5 allows the remote controller 46 to combine the native controller setpoint P1 with the remote controller control signal output C2 to produce the modified feedback signal S6 for the native controller. When the native controller receives the modified feedback signal S6 (in lieu of sensor feedback of the injection molding apparatus indicating the measured value of the control variable) and combines the modified feedback signal with the native controller setpoint (as the native controller was previously configured to do with the measured control variable value), this latter combining effectively cancels out the role of the native controller setpoint in the control of the control variable at the native controller 40.

Accordingly, using techniques of the present disclosure, the error signal E1 provided to the control algorithm G1 may be substantially equal to the control signal C2 generated by the remote controller 46 (plus the feedforward component FF1, in some instances), thereby allowing for control of the injection molding apparatus 10 while minimizing the impact of the native controller setpoint in the behavior of the control variable (e.g., minimizing amplitude of oscillation and eliminating higher-order oscillation of the control variable). Notably, this effect can be achieved via the techniques regardless of the particular value(s) of the setpoints used by the native controller and/or remote controller, and regardless of whether the native controller setpoint and/or the remote controller setpoint are configured to change over the course of an injection molding cycle. That is, the same behavior of the control variable with respect to overshoot, settling time, etc., can be observed and managed by the remote controller, regardless of what setpoint values for the control variable are used.

### Additional Considerations

The foregoing description of embodiments and examples has been presented for purposes of illustration and description. It is not intended to be exhaustive or limiting to the forms described. For, example, although the remote controller 46 is described as being provided on an injection molding apparatus, a remote controller can be provided on any apparatus that employs feedback control from a native controller to add functionality to the apparatus where the native controller is not capable of providing such functionality independently. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

### Examples/Combinations

A. A method of manipulating control of an operation of an actuation unit of an apparatus using a remote controller configured via a retrofitting of the remote controller to a native controller of the apparatus, the native controller prior to the retrofitting being configured to control the operation of the actuation unit based upon a first signal indicative of a first control variable of the apparatus, the method comprising:
sensing the first control variable of the apparatus at a sensor;
generating the first signal based upon the first control variable;
generating a second signal based upon a first setpoint of the native controller for the first control variable;
at the remote controller:
   receiving the first and second signals;
   generating a control signal based upon the first signal and a second setpoint of the remote controller for the first control variable;
   combining the generated control signal and the second signal to produce a modified feedback signal; and
   transmitting the modified feedback signal to the native controller in lieu of the first signal; and
at the native controller, controlling the operation of the actuation unit based at least in part on the modified feedback signal.

B. The method of paragraph A, wherein the apparatus comprises an injection molding apparatus comprising a heated barrel and an injection shaft, the actuation unit being operatively coupled to the injection shaft, and wherein the operation of the actuation unit facilitates operation of the injection shaft with respect to the heated barrel.

C. The method of paragraph B, wherein the injection shaft comprises a reciprocating screw, wherein the operation of the actuation unit facilitates a reciprocation of the reciprocating screw.

D. The method of paragraph B or C, wherein the injection shaft comprises a plunger, wherein the operation of the actuation unit facilitates a reciprocation of the plunger.

E. The method of any one of paragraphs B-D, wherein the actuation unit comprises one of a hydraulic motor and an electric motor.

F. The method of any one of paragraphs B-E, wherein the first control variable of the injection molding apparatus is one of a injection pressure of the heated barrel, a temperature of the heated barrel, and a volume of a hopper included in the injection molding apparatus.

G. The method of any one of paragraphs B-F, wherein the first control variable of the injection molding apparatus is a melt pressure of the heated barrel.

H. The method of any one of paragraphs B-G, wherein the first control variable of the injection molding apparatus is a cavity pressure of the injection molding apparatus.

I. The method of any one of paragraphs A-H, wherein the generating of the control signal at the remote controller comprises:
comparing the first signal to the second setpoint for the first control variable; and
generating the control signal based upon a difference between the first signal and the second setpoint.

J. The method of paragraph I, wherein the generating of the control signal at the remote controller comprises providing the difference as an input to a PID control algorithm of the remote controller to generate the control signal.

K. The method of paragraph J, wherein the PID control algorithm of the remote controller is a first PID control algorithm, and wherein the controlling of the operation of the actuation unit at the native controller based upon the modified feedback signal comprises providing the modified feedback signal as an input to a second PID control algorithm of the native controller that is different from the first PID control algorithm.

L. The method of any one of paragraphs A-K, wherein the second setpoint of the remote controller is a setpoint for the first control variable.

M. The method of any one of paragraphs A-L, wherein the second setpoint of the remote controller is a setpoint for a second control variable different from the first control variable.

N. An apparatus comprising:
an actuation unit;
a native controller in communication with the actuation unit and configured to control an operation of the actuation unit, the native controller storing a first setpoint of the native controller for a first control variable of the apparatus;
a remote controller in communication with the native controller via a retrofitting of the remote controller to a native controller, the native controller prior to the retrofitting being configured to control the operation of the actuation unit based upon a first signal indicative of first the control variable of the apparatus; and
a sensor in communication with the remote controller and configured to sense the first control variable and generate a first signal based upon the first control variable,
wherein the remote controller is configured to:
   receive, from the sensor, the first signal,
   receive, from the native controller, a second signal indicative of the first setpoint for the first control variable,
   generate a control signal based upon the first signal and a second setpoint of the remote controller for the first control variable,
   combine the generated control signal and the second signal to produce a modified feedback signal; and
   transmit the modified feedback signal to the native controller in lieu of the first signal,
and wherein the native controller is configured to control the operation of the actuation unit based at least in part on the modified feedback signal.

O. The apparatus of paragraph N, further comprising an injection molding apparatus comprising a heated barrel and an injection shaft, the actuation unit being operatively coupled to the injection shaft, and wherein the operation of the actuation unit facilitates operation of the injection shaft with respect to the heated barrel.

P. The apparatus of paragraph O, wherein the injection shaft comprises a reciprocating screw, wherein the operation of the actuation unit facilitates a reciprocation of the reciprocating screw.

Q. The apparatus of paragraph O or P, wherein the injection shaft comprises a plunger, wherein the operation of the actuation unit facilitates a reciprocation of the plunger.

R. The apparatus of any one of paragraphs O-Q, wherein the actuation unit comprises one of a hydraulic motor and an electric motor.

S. The apparatus of any one of paragraphs O-R, wherein the first control variable of the injection molding apparatus is one of an injection pressure of the heated barrel, a temperature of the heated barrel, and a volume of a hopper included in the injection molding apparatus.

T. The apparatus of any one of paragraphs O-S, wherein the first control variable of the injection molding apparatus is a melt pressure of the heated barrel.

U. The apparatus of any one of paragraphs O-T, wherein the first control variable of the injection molding apparatus is a cavity pressure of the injection molding apparatus.

V. The apparatus of any one of paragraphs N-U, wherein the generating of the control signal at the remote controller comprises:
comparing the first signal to the second setpoint for the first control variable; and
generating the control signal based upon a difference between the first signal and the second setpoint.

W. The apparatus of paragraph V, wherein the generating of the control signal at the remote controller comprises providing the difference as an input to a PID control algorithm of the remote controller to generate the control signal.

X. The apparatus of paragraph W, wherein the PID control algorithm of the remote controller is a first PID control algorithm, and wherein the controlling of the operation of the actuation unit at the native controller based upon the modified feedback signal comprises providing the modified feedback signal as an input to a second PID control algorithm of the native controller that is different from the first PID control algorithm.

Y. The apparatus of any one of paragraphs N-X, wherein the second setpoint of the remote controller is a setpoint for the first control variable.

Z. The apparatus of any one of paragraphs N-Y, wherein the second setpoint of the remote controller is a setpoint for a second control variable different from the first control variable.

AA. The method according to any one of paragraphs A-M, modified according to the method of any other suitable one or more of paragraphs A-M.

AB. The apparatus according to any one of paragraphs N-Z, modified according to the apparatus of any other suitable one or more of paragraphs N-Z.

What is claimed is:

1. A method of manipulating control of an operation of an actuation unit of an apparatus using a remote controller configured via a retrofitting of the remote controller to a native controller of the apparatus, the native controller prior to the retrofitting being configured to control the operation of the actuation unit based upon a first signal indicative of a first control variable of the apparatus, the method comprising:
sensing the first control variable of the apparatus at a sensor;
generating the first signal based upon the first control variable;
generating a second signal based upon a first setpoint of the native controller for the first control variable;
at the remote controller:
receiving the first and second signals;
generating a control signal based upon the first signal and a second setpoint of the remote controller for the first control variable;
combining the generated control signal and the second signal to produce a modified feedback signal; and
transmitting the modified feedback signal to the native controller in lieu of the first signal; and
at the native controller, controlling the operation of the actuation unit based at least in part on the modified feedback signal.

2. The method of claim 1, wherein the apparatus comprises an injection molding apparatus comprising a heated barrel and an injection shaft, the actuation unit being operatively coupled to the injection shaft, and wherein the operation of the actuation unit facilitates operation of the injection shaft with respect to the heated barrel.

3. The method of claim 2, wherein the injection shaft comprises a reciprocating screw, wherein the operation of the actuation unit facilitates a reciprocation of the reciprocating screw.

4. The method of claim 2, wherein the injection shaft comprises a plunger, wherein the operation of the actuation unit facilitates a reciprocation of the plunger.

5. The method of claim 2, wherein the actuation unit comprises one of a hydraulic motor and an electric motor.

6. The method of claim 2, wherein the first control variable of the injection molding apparatus is one of a injection pressure of the heated barrel, a temperature of the heated barrel, and a volume of a hopper included in the injection molding apparatus.

7. The method of claim 2, wherein the first control variable of the injection molding apparatus is a melt pressure of the heated barrel.

8. The method of claim 2, wherein the first control variable of the injection molding apparatus is a cavity pressure of the injection molding apparatus.

9. The method of claim 1, wherein the generating of the control signal at the remote controller comprises:
comparing the first signal to the second setpoint for the first control variable; and
generating the control signal based upon a difference between the first signal and the second setpoint.

10. The method of claim 9, wherein the generating of the control signal at the remote controller comprises providing the difference as an input to a PID control algorithm of the remote controller to generate the control signal.

11. The method of claim 10, wherein the PID control algorithm of the remote controller is a first PID control algorithm, and wherein the controlling of the operation of the actuation unit at the native controller based upon the modified feedback signal comprises providing the modified feedback signal as an input to a second PID control algorithm of the native controller that is different from the first PID control algorithm.

12. The method of claim 1, wherein the second setpoint of the remote controller is a setpoint for the first control variable.

13. The method of claim 1, wherein the second setpoint of the remote controller is a setpoint for a second control variable different from the first control variable.

14. An apparatus comprising:
an actuation unit;
a native controller in communication with the actuation unit and configured to control an operation of the actuation unit, the native controller storing a first setpoint of the native controller for a first control variable of the apparatus;
a remote controller in communication with the native controller via a retrofitting of the remote controller to a native controller, the native controller prior to the retrofitting being configured to control the operation of the actuation unit based upon a first signal indicative of first the control variable of the apparatus; and
a sensor in communication with the remote controller and configured to sense the first control variable and generate a first signal based upon the first control variable,
wherein the remote controller is configured to:
receive, from the sensor, the first signal,
receive, from the native controller, a second signal indicative of the first setpoint for the first control variable,
generate a control signal based upon the first signal and a second setpoint of the remote controller for the first control variable,
combine the generated control signal and the second signal to produce a modified feedback signal; and
transmit the modified feedback signal to the native controller in lieu of the first signal,
and wherein the native controller is configured to control the operation of the actuation unit based at least in part on the modified feedback signal.

15. The apparatus of claim 14, further comprising an injection molding apparatus comprising a heated barrel and an injection shaft, the actuation unit being operatively coupled to the injection shaft, and wherein the operation of the actuation unit facilitates operation of the injection shaft with respect to the heated barrel.

16. The apparatus of claim 15, wherein the injection shaft comprises a reciprocating screw, wherein the operation of the actuation unit facilitates a reciprocation of the reciprocating screw.

17. The apparatus of claim 15, wherein the injection shaft comprises a plunger, wherein the operation of the actuation unit facilitates a reciprocation of the plunger.

18. The apparatus of claim 15, wherein the actuation unit comprises one of a hydraulic motor and an electric motor.

19. The apparatus of claim 15, wherein the first control variable of the injection molding apparatus is one of an injection pressure of the heated barrel, a temperature of the heated barrel, and a volume of a hopper included in the injection molding apparatus.

20. The apparatus of claim 15, wherein the first control variable of the injection molding apparatus is a melt pressure of the heated barrel.

21. The apparatus of claim 15, wherein the first control variable of the injection molding apparatus is a cavity pressure of the injection molding apparatus.

22. The apparatus of claim 14, wherein the generating of the control signal at the remote controller comprises:
comparing the first signal to the second setpoint for the first control variable; and
generating the control signal based upon a difference between the first signal and the second setpoint.

23. The apparatus of claim 22, wherein the generating of the control signal at the remote controller comprises providing the difference as an input to a PID control algorithm of the remote controller to generate the control signal.

24. The apparatus of claim 23, wherein the PID control algorithm of the remote controller is a first PID control algorithm, and wherein the controlling of the operation of the actuation unit at the native controller based upon the modified feedback signal comprises providing the modified feedback signal as an input to a second PID control algorithm of the native controller that is different from the first PID control algorithm.

25. The apparatus of claim 14, wherein the second setpoint of the remote controller is a setpoint for the first control variable.

26. The apparatus of claim 14, wherein the second setpoint of the remote controller is a setpoint for a second control variable different from the first control variable.
